(19) United States
(12) Patent Application Publication
(10) Pub. No.: US 2012/0169780 A1
(43) Pub. Date: Jul. 5, 2012

(54) METHOD OF COMPENSATING DATA, DATA COMPENSATING APPARATUS FOR PERFORMING THE METHOD AND DISPLAY APPARATUS HAVING THE COMPENSATING APPARATUS

(75) Inventors: Bong-Im PARK, Asan-si (KR); Seon-Ki KIM, Anyang-si (KR); Jun-Pyo LEE, Asan-si (KR); Ik-Huyn AHN, Asan-si (KR); Ho-Seok SON, Incheon (KR); Kang-Min KIM, Seoul (KR); Jung-Won KIM, Seoul (KR)

(73) Assignee: SAMSUNG ELECTRONICS CO., LTD., Suwon-si (KR)

(21) Appl. No.: 13/214,351

(22) Filed: Aug. 22, 2011

(30) Foreign Application Priority Data
Dec. 31, 2010 (KR) 2010-0139823

(51) Int. Cl. G09G 5/10

(52) U.S. Cl. 345/690

(57) ABSTRACT

A method of compensating data includes extending a number of bits of data and outputting extended data of a first color, compensating a luminance of the extended data of the first color based on a position of the extended data of the first color in a display panel and outputting compensated data of the first color, and outputting compensated data of a second color and compensated data of a third color based on the compensated data of the first color.

This application claims priority to Korean Patent Application No. 2010-139823, filed on Dec. 31, 2010, and all the benefits accruing therefrom under 35 U.S.C. §119, the content of which in its entirety is herein incorporated by reference.

### BACKGROUND OF THE INVENTION

(1) Field of the Invention

Exemplary embodiments of the present invention relate to a method of compensating data, a data compensating apparatus for performing the method and a display apparatus having the data compensating apparatus. More particularly, exemplary embodiments of the present invention relate to a method of compensating data which prevents luminance ununiformity and crosstalk error, a data compensating apparatus for performing the method and a display apparatus having the data compensating apparatus.

(2) Description of the Related Art

A liquid crystal display (“LCD”) apparatus typically includes an LCD panel displaying an image using light transmittance of a liquid crystal, and a backlight assembly disposed under the LCD panel and which provides light to the LCD panel.

Generally, a red pixel, a green pixel and a blue pixel of the LCD apparatus have optical characteristics different from each other. However, the LCD apparatus is generally driven by electrical signals without considering difference in the optical characteristics of the red, green and blue pixels. Accordingly, gamma characteristics of the red, green and blue pixels, which are independently measured, do not coincide with each other. Therefore, color characteristics corresponding to grayscales are not consistent and color characteristics are oriented to a specific color.

To solve the above mentioned problem, an adaptive color correction (“ACC”) technology has been employed to the LCD apparatus. In the ACC technology, a red gamma curve, a green gamma curve and a blue gamma curve are independently adjusted to improve display quality of the LCD apparatus. The ACC technology typically uses a memory, such as a read-only memory (“ROM”) and random-access memory (“RAM”), for example, to store compensated data, which is mapped to input data in one-to-one correspondence, as a lookup table type. When input data are received from outside, compensated data corresponding to the input data are outputted based on the lookup table.

In addition, luminance difference in pixels may be caused by a propagation delay of a data signal and a gate signal depending on a position in the LCD panel. The crosstalk error may be caused by response characteristics of the liquid crystal, a scanning time of the backlight assembly, a shutter glass on/off time for left eye and right eye in three dimensional display apparatus.

To prevent the crosstalk error, a method of turning off the backlight assembly or applying black data to the LCD panel corresponding to a period, when the crosstalk error is occurred, may be used. However, luminance of the LCD panel may be decreased by turning off the backlight assembly or applying the black data.

### BRIEF SUMMARY OF THE INVENTION

Exemplary embodiments of the present invention provide a method of compensating data which prevents luminance ununiformity and crosstalk error of a display panel.

Exemplary embodiments of the present invention also provide a data compensating apparatus for performing the method of compensating data.

Exemplary embodiments of the present invention also provide a display apparatus having the data compensating apparatus.

In an exemplary embodiment, a method of compensating data includes: extending a number of bits of data and outputting extended data of a first color; compensating a luminance of the extended data of the first color based on a position of the extended data of the first color in a display panel and outputting compensated data of the first color; and outputting compensated data of a second color and compensated data of a third color based on the compensated data of the first color.

In an exemplary embodiment, the method may further include delaying an output timing of the compensated data of the first color

In an exemplary embodiment, the first color may be green, and the second and third colors may be red and blue, respectively.

In an exemplary embodiment, the extending the number of bits of the data may include using a first lookup table which stores the data and the extended data of the first color corresponding to the data.

In an exemplary embodiment, the compensating a luminance of the extended data of the first color may include multiplying the extended data of the first color by position data corresponding to the position of the extended data of the first color in the display panel.

In an exemplary embodiment, the outputting compensated data of the second color and compensated data of the third color may include using a second lookup table and a third lookup table, where the second lookup table stores the compensated data of the first color, and the compensated data of the second color corresponding to the compensated data of the first color, and the third lookup tables stores the compensated data of the first color and the compensated data of the third colors corresponding to the compensated data of the first color.

In an exemplary embodiment, the second lookup table and the third lookup table store sampled addresses of the compensated data of the second color and sampled addresses of the compensated data of the third color, respectively.

In an exemplary embodiment, the outputting compensated data of the second color and compensated data of the third color may further include calculating the compensated data of the second color and the compensated data of the third color by linear interpolation.

In an alternative exemplary embodiment, a data compensating apparatus includes a bit extending part which extends a number of bits of data and outputs extended data of a first color; a luminance compensating part which compensates a luminance of the extended data of the first color based on a position of the extended data of the first color in a display panel and outputs compensated data of the first color; and an output part which outputs compensated data of a second color and compensated data of third color based on the compensated data of the first color.

In an exemplary embodiment, the data compensating apparatus may further include a delaying part which delays an output timing of the compensated data of the first color.

In an exemplary embodiment, the first color may be green, and the second and third colors may be red and blue, respectively

In an exemplary embodiment, the bit extending part may include a first lookup table which stores the data and the extended data of the first color corresponding to the data.

In an exemplary embodiment, the luminance compensating part may multiply the extended data of the first color by position data corresponding to the position of the extended data of the first color in the display panel.

In an exemplary embodiment, the output part may include a second lookup table which stores the compensated data of the first color, and the compensated data of the second color corresponding to the compensated data of the first color, and a third lookup table which stores the compensated data of the first color, and the compensated data of the third color corresponding to the compensated data of the first color.

In an exemplary embodiment, the second lookup table and the third lookup table store sampled addresses of the compensated data of the second color and sampled addresses of the compensated data of the third color, respectively.

In an exemplary embodiment, the output part may calculate the compensated data of the second color and the compensated data of the third color by linear interpolation.

In another alternative exemplary embodiment, the display apparatus includes a timing controller including a data compensating apparatus, a display panel including a data line and a gate line crossing the data line, a data driver which converts at least one of the compensated data of the first color, the compensated data of the second color and the compensated data of the third color to an analogue data voltage and outputs the analogue data voltage to the data line, and a gate driver which outputs a gate signal to the gate line. The data compensating apparatus includes a bit extending part which extends a number of bits of data and outputs extended data of a first color; a luminance compensating part which compensates a luminance of the extended data of the first color based on a position of the extended data of the first color in a display panel and outputs compensated data of the first color; and an output part which outputs compensated data of a second color and compensated data of a third color based on the compensated data of the first color.

In an exemplary embodiment, the data compensating apparatus may further include a delaying part which delays an output timing of the compensated data of the first color.

In an exemplary embodiment, the bit extending part may include a first lookup table which stores the data and the extended data of the first color corresponding to the data.

In an exemplary embodiment, the output part may include second lookup table which stores the compensated data of the first color, and the compensated data of the second color corresponding to the compensated data of the first color, and a third lookup table which stores the compensated data of the first color, and the compensated data of the third color corresponding to the compensated data of the first color.

According to exemplary embodiments, luminance difference due to position difference in a display panel is compensated such that luminance ununiformity of the display panel is effectively prevented, and display quality of the display panel is thereby substantially improved. In addition, a crosstalk error related with the luminance difference is also effectively prevented such that the display quality of the display panel is substantially improved.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is a block diagram illustrating an exemplary embodiment of a display apparatus according to the present invention;

FIG. 2 is a block diagram illustrating an exemplary embodiment of a timing controller of FIG. 1;

FIG. 3 is a block diagram illustrating an exemplary embodiment of a data compensating part of FIG. 2;

FIG. 4 is a conceptual diagram illustrating an exemplary embodiment of a first lookup table in a bit extending part of FIG. 3;

FIGS. 5 and 6 are conceptual diagrams illustrating exemplary embodiments of second and third lookup tables in an output part of FIG. 3;

FIG. 7 is a graph illustrating extended data and first to third color compensated data corresponding to data inputted to the data compensating part of FIG. 2;

FIG. 8 is a flowchart showing an exemplary embodiment of a method of compensating data implemented by the data compensating part of FIG. 3; and

FIG. 9 is a block diagram illustrating an alternative exemplary embodiment of the data compensating part according to the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower, ” “under,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “above” relative to the other elements or features. Thus, the exemplary term “lower” and “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the present invention will be explained in detail with reference to the accompanying drawings.

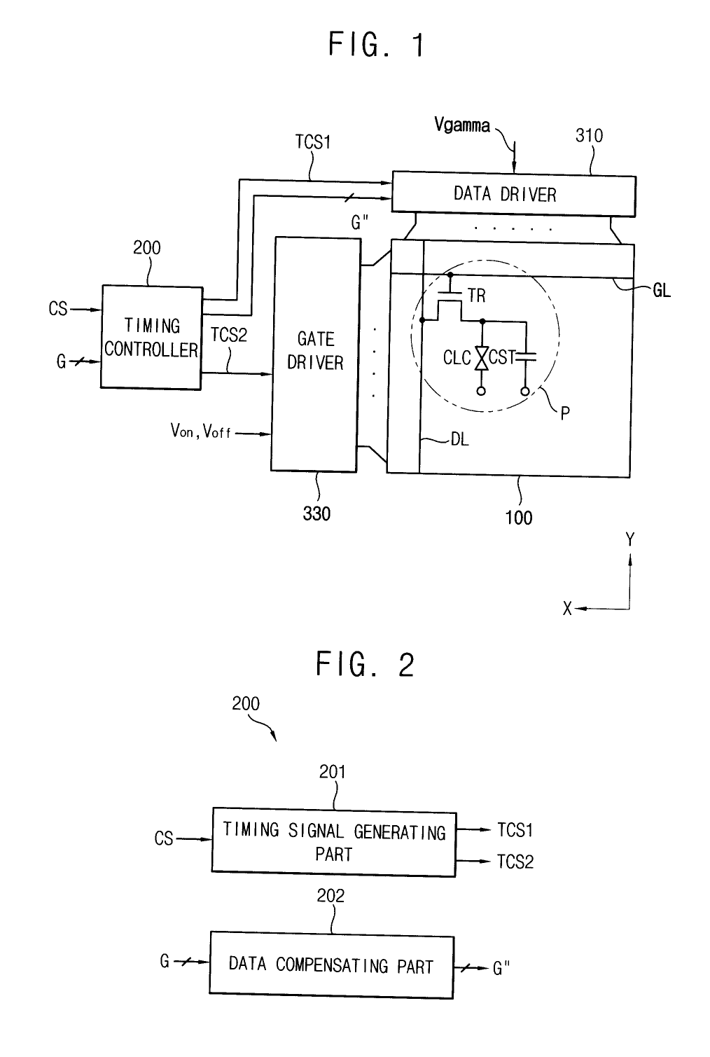

FIG. 1 is a block diagram illustrating an exemplary embodiment of a display apparatus according to the present invention. FIG. 2 is a block diagram illustrating an exemplary embodiment of a timing controller of FIG. 1.

Referring to FIGS. 1 and 2, the display apparatus includes a display panel 100, a timing controller 200, a data driver 310 and a gate driver 330.

The display panel 100 includes an array substrate, an opposite substrate and a liquid crystal layer disposed between the array and opposite substrates. The display panel 100 includes a plurality of data lines DL, a plurality of gate lines GL crossing the data lines DL, and a plurality of pixels P electrically connected to the data lines DL and the gate lines GL.

In one exemplary embodiment, for example, the gate lines may extend in a first direction x, and the data lines DL may extend in a second direction y substantially perpendicular to the first direction x. The pixel P includes a switching element TR, a liquid crystal capacitor CLC and a storage capacitor CST.

The timing controller 200 receives a control signal CS and data G from outside. The data G are digital data corresponding to grayscales of an image. The timing controller 200 includes a timing signal generating part 201 and a data compensating part 202.

The timing signal generating part 201 generates a plurality of timing signals for driving the display apparatus using the control signal CS. The timing signals include a data control signal TCS1 and a gate control signal TCS2.

In one exemplary embodiment, for example, the data control signal TCS1 may include a horizontal sync signal, a load signal, an inverting signal and a data clock signal, which are used to control the data driver 310. The gate control signal TCS2 may include a vertical sync signal, a gate clock signal and a gate enable signal, which are used to control the gate driver 330.

The data compensating part 202 outputs compensated data G″ corresponding to the data G The compensated data G″ may include data corresponding to a plurality of colors. In an exemplary embodiment, the plurality of the colors may be first to third colors.

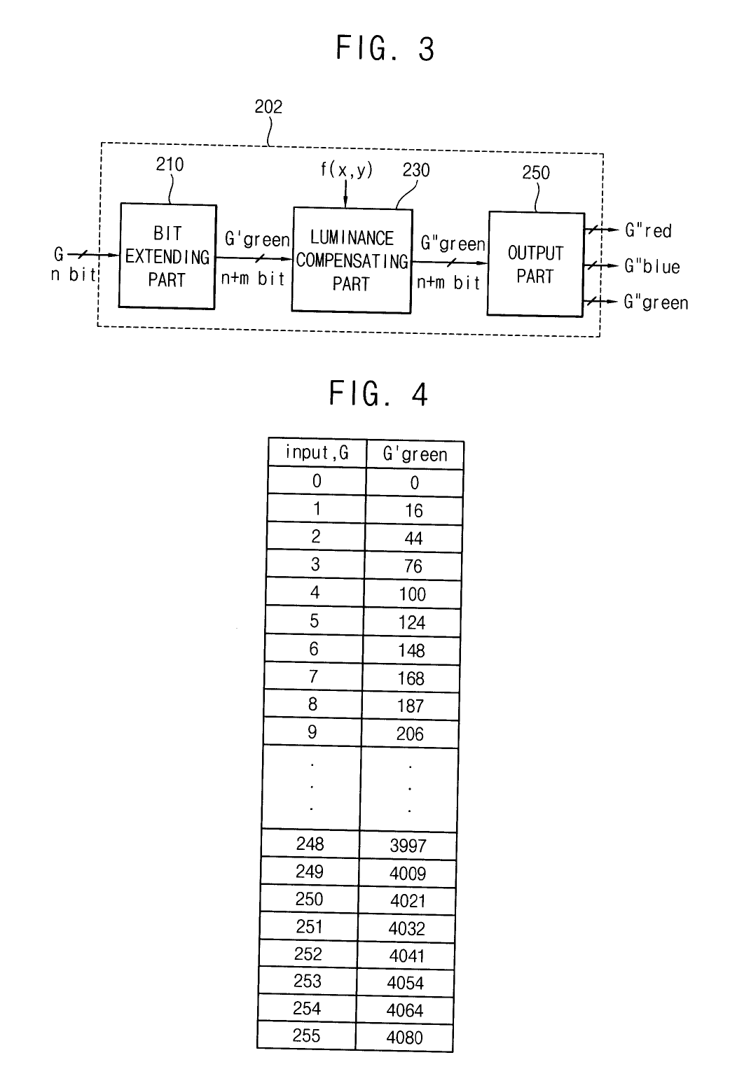

The data compensating part 202 may include a memory which stores the compensated data G″ corresponding to the data G as a lookup table type. The data compensating part 202 will be described later in detail referring to FIG. 3.

The data driver 310 converts the compensated data G″ to a data voltage in an analogue type based on the data control signal TCS1. The data driver 310 converts the compensated data G″ to the data voltage using a gamma voltage Vgamma The data driver 310 outputs the data voltage to a corresponding data line of the data lines DL of the display panel 100.

The gate driver 330 generates a gate signal based on the gate control signal TCS2. The gate driver 330 generates the gate signal using a turn-on voltage Von and a turn-off voltage Voff. The gate driver 330 output the gate signal to a corresponding gate line of the gate lines GL of the display panel 100.

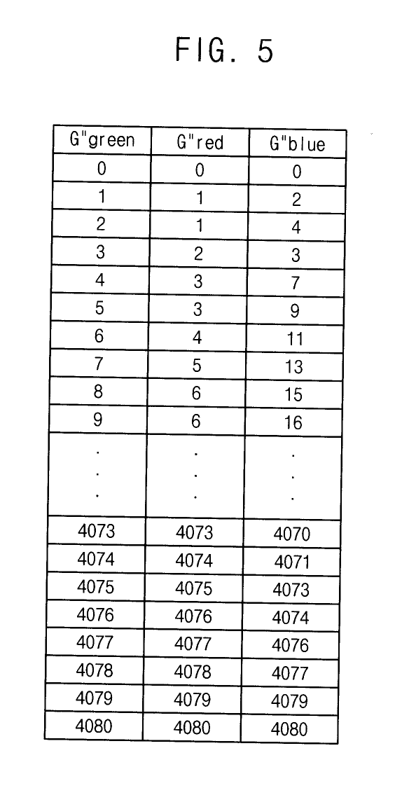

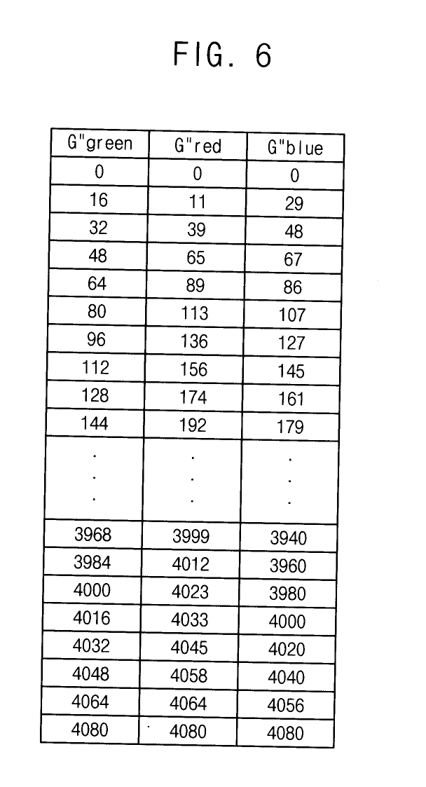

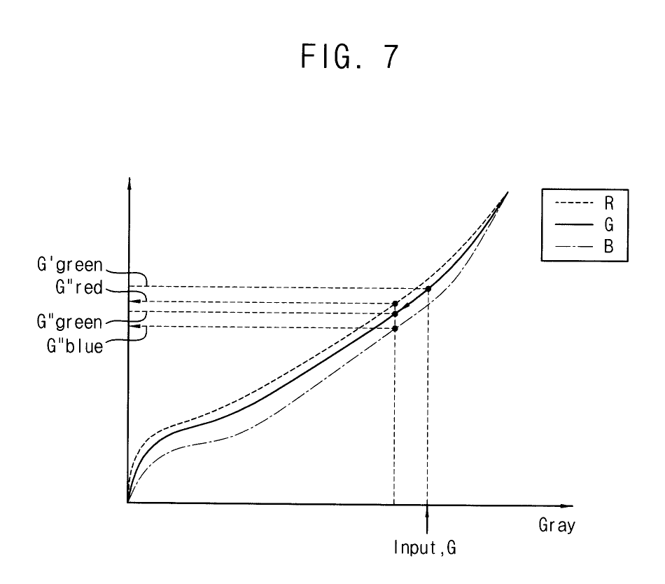

FIG. 3 is a block diagram illustrating an exemplary embodiment of a data compensating part of FIG. 2. FIG. 4 is a conceptual diagram illustrating a first lookup table in a bit extending part of FIG. 3. FIGS. 5 and 6 are conceptual diagrams illustrating exemplary embodiments of second and third lookup tables in an output part of FIG. 3. FIG. 7 is a graph illustrating extended data and first to third color compensated data corresponding to data inputted to the data compensating part of FIG. 2.

Referring to FIG. 3, an exemplary embodiment of the data compensating part 202 includes a bit extending part 210, a luminance compensating part 230 and an output part 250.

The bit extending part 210 extends a number of bits of the data G to output extended data G′ of a first color. The bits of the data G are extended such that luminance change by grayscale change may be minimized In an exemplary embodiment, when the data G is n-bit data, the extended data G′ of the first color may be (n+m)-bit data, where n and m are natural numbers.

The bit extending part 210 may include a first lookup table storing the data G and the extended data G′ of the first color and corresponding to the data G The first color may be one of red, green and blue. In one exemplary embodiment, for example, the first color may be the green, which substantially influences luminance of the display panel such that the bit extending part 210 outputs green extended data G′green.

FIG. 4 shows an exemplary embodiment of the first lookup table when n is 8 and m is 4. As shown in FIG. 4, data G have grayscales represented with values between 0 and 255, and the green extended data G′green have grayscales represented with values between 0 and 4080. The data G are mapped one-to-one with the green extended data G′green. In an exemplary embodiment, the first lookup table may store the green extended data G′green based on gamma tuning or white balance tuning.

The bit extended part 210 extends the data G of n bits to output the green extended data G′green of n+m bits.

The luminance compensating part 230 outputs green compensated data G″green by compensating luminance difference of the green extended data G′green due to different data positions thereof in the display panel 100. The luminance difference of the green extended data G′green may be caused by a propagation delay of the gate signal and the data signal applied to the gate line GL and the data line DL, respectively, and by response characteristics of the liquid crystal in the liquid crystal layer.

The luminance compensating part 230 may output the green compensated data G″green based on the green extended data G′green applied from the bit extending part 210. The green compensated data G″green may be defined as following Equation 1.

G″(N)=f(x, y)G′(N) [Equation 1]

In Equation 1, “N” is n+m, which is the number of bits of the extended data G′. “f(x,y)” is position data in the display panel 100, which is defined as a first coordinate in the first direction x and a second coordinate in the second direction y in the display panel 100. Accordingly, the green color extended data G′green may be increased or decreased by f(x,y) such that the luminance of the green extended data G′green may be compensated based on the position of the green extended data G′green in the display panel 100.

In on exemplary embodiment, for example, the luminance of the green extended data G′green may be linearly compensated based on the position thereof in the display panel 100 using an equation such as following Equation 2-1.

f(x,y)=αy+β [Equation 2-1]

In an alternative exemplary embodiment, the luminance of the green extended data G′green may be compensated based on the position thereof in the display panel 100 using a quadratic equation such as following Equation 2-2.

f(x,y)=αy²+βy+γ [Equation 2-2]

In an alternative exemplary embodiment, the luminance of the green extended data G′green may be compensated based on the position thereof in the display panel 100 using a cubic equation such as following Equation 2-3.

f(x,y)=αy³+βy²+γy+δ [Equation 2-3]

In an alternative exemplary embodiment, the luminance of the green extended data G′green may be compensated based on the position thereof in the display panel 100 using an equation related with variable x, or variables x and y. The luminance difference depending on the position in the display panel 100 may be compensated based on the position thereof in the display panel 100 using following Equations 2-4 to 2-7.

f(x,y)=αx+β [Equation 2-4]

f(x,y)=αx²+βx+γ [Equation 2-5]

f(x,y)=αx³+βx²+γx+δ [Equation 2-6]

f(x,y)=αxy+βx+γy+δ [Equation 2-7]

In an exemplary embodiment, the green compensated data G″green outputted from the luminance compensating part 230 are green data to be outputted from the data compensating part 202. The green compensated data G″green are provided to the output part 250.

The output part 250 outputs compensated data of second and third colors using the green compensated data G″green provided from the luminance compensating part 230. The second and third colors may be the red and the blue, respectively. The output part 250 outputs red compensated data G″red and blue compensated data G″blue. The red compensated data G″red and the blue compensated data G″blue are the blue and red data to be outputted from the data compensating part 202.

The output part 250 may include a second lookup table that stores the green compensated data G″green and the red compensated data G″red corresponding to the green compensated data G″green. The output part 250 may include a third lookup table that stores the green compensated data G″green and the blue compensated data G″blue corresponding to the green compensated data G″green. In an exemplary embodiment, the second and third lookup tables may be formed integrally in a single table having three columns as shown in FIGS. 5 and 6. In an alternative exemplary embodiment, the second and third lookup tables may be formed independently from each other.

FIG. 5 shows exemplary embodiments of second and third lookup tables when the green compensated data G″green includes 4081 addresses from 0 to 4080.

In an exemplary embodiment, the second and third lookup tables store the compensated data for some sampled addresses to decrease sizes of the second and third lookup tables. FIG. 6 shows exemplary embodiments of second and third lookup tables when the addresses are sampled in every 16 addresses, in which the number of addresses is 256.

The output part 250 may calculate the compensated data corresponding to addresses not sampled by linear interpolation. The green compensated data G″green, the red compensated data G″red and the blue compensated data G″blue corresponding to i-th address, which is between the sampled addresses are defined as following Equation 3.

$${G}_{red ( green or blue )}^{″} [ i ] = {G}_{red ( green or blue )}^{″} [ j ] + \frac{( {G}^{″} [ j + 1 ] - {G}^{″} [ i ] )}{{2}^{m}} ( {G}_{red ( green or blue )}^{″} [ j + 1 ] - {G}_{red ( green or blue )}^{″} [ j ] ) \qquad [ Equation 3 ]$$

In Equation 3, “i”″ is a natural number greater than or equal to 0. More particularly, “i”″ is a natural number less than or equal to 2^{N}−1. In addition, “j” is also a natural number greater than or equal to 0. More particularly, “j” is a natural number less than or equal to 2^{N}−1. When only the compensated data corresponding to the sampled addresses are stored in the second and third lookup tables, a size of a memory that stores the second and third lookup tables substantially decreases.

FIG. 7 is a graph showing output data corresponding to the data G inputted to the data compensating part 202. More particularly, the output data includes the green extended data G′green, the green compensated data G″green, the red compensated data G″red and the blue compensated data G″blue.

Curves in FIG. 7 shows red, green and blue grayscale data forming a white balance state. In an exemplary embodiment, the green compensated data G″green, the red compensated data G″red and the blue compensated data G″blue form the white balance state.

In an exemplary embodiment, the red compensated data G″red and the blue compensated data G″blue are outputted using the green compensated data G″green whose luminance is compensated based on a position thereof in the display panel 100. In an exemplary embodiment, a conventional ratio among the red, green and blue grayscale data forming the white balance state may be used. Therefore, the luminance ununiformity may be compensated using a conventional adaptive color correction (“ACC”) curve without an additional program to define the grayscale data, and display quality of the display panel is thereby substantially improved

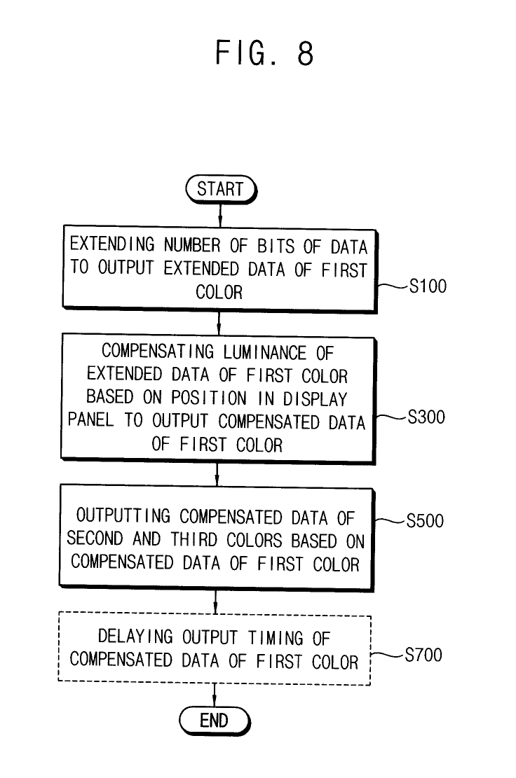

FIG. 8 is a flow chart showing an exemplary embodiment of a method of compensating data implemented by the data compensating part of FIG. 3.

Referring to FIG. 8, the bit extending part 210 extends the number of bits of the data G to output extended data G′ of a first color (step S100). In an exemplary embodiment, the first color may be the green. The bit extending part 210 may include the first lookup table storing the green extended data G′green corresponding to the data G.

The luminance compensating part 230 outputs green compensated data G″green by compensating a luminance of the green extended data G′green based on a position of the green extended data G′green in the display panel 100 (step S300). The luminance compensating part 230 may output the green compensated data G″green based on the green extended data G′green applied to the bit extending part 210. The green compensated data G″green may be defined as Equation 1, described above.

The output part 250 outputs compensated data of second and third colors using the green compensated data G″green provided from the luminance compensating part 230 (step S500). In an exemplary embodiment, the second and third colors may be the red and the blue, respectively. The output part 250 outputs red compensated data G″red and blue compensated data G″blue.

The output part 250 may include a second lookup table that stores the green compensated data G″green and the red compensated data G″red corresponding to the green compensated data G″green. The output part 250 may include a third lookup table that stores the green compensated data G″green and the blue compensated data G″blue corresponding to the green compensated data G″green. In an exemplary embodiment, the second and third lookup tables may be formed integrally as a single table having three columns as shown in FIGS. 5 and 6. In an alternative exemplary embodiment, the second and third lookup tables may be formed independently from each other.

In an exemplary embodiment, the second and third lookup tables store the compensated data for some sampled addresses to decrease sizes of the second and third lookup tables. The output part 250 may calculate the compensated data corresponding to addresses not sampled by linear interpolation using Equation 3.

In an exemplary embodiment, only the compensated data corresponding to the sampled addresses are stored in the second and third lookup tables, and a size of a memory that stores the second and third lookup tables may be substantially reduced.

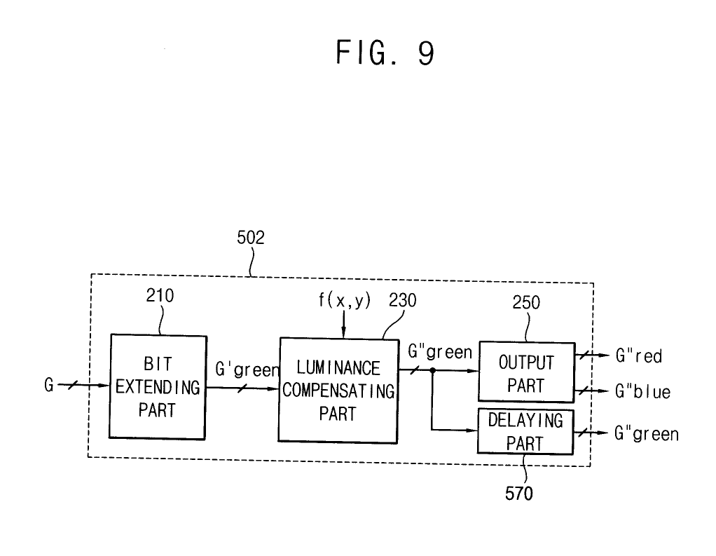

FIG. 9 is a block diagram illustrating an alternative exemplary embodiment of the data compensating part according to the present invention.

The data compensating part 502 in FIG. 9 is substantially the same as the data compensating part 202 shown in FIG. 3 except that the data compensating part 502 further includes a delaying part 570. Thus, the same or like elements shown in FIG. 9 has been labeled with the same reference numerals used to describe the exemplary embodiment of the data compensating part 502 in FIG. 3, and any repetitive detailed description thereof will be omitted or simplified.

As shown in FIG. 9, the data compensating part 502 includes a bit extending part 210, a luminance compensating part 230, an output part 250 and a delaying part 570.

The delaying part 570 delays an output of the green compensated data G″green provided from the luminance compensating part 230. The green compensated data G″green outputted from the luminance compensating part 230 are the green data to be outputted from the data compensating part 502. The red compensated data G″red and the blue compensated data G″blue outputted from the output part 250 are the blue and red data to be outputted from the data compensating part 502.

Accordingly, the delaying part 570 adjusts an output timing of the green compensated data G″green to be in synchronized with an output timing of the red compensated data G″red and the blue compensated data G″blue.

The method of compensating data used in the exemplary embodiment of FIG. 9 is substantially the same as the exemplary embodiment of the method of compensating data described above referring to FIG. 8 except that the method of compensating data used in the exemplary embodiment of FIG. 9 further includes step 700. Thus, any repetitive detailed descriptions thereof will be omitted.

In an exemplary embodiment, the delaying part 570 may delay the output of the green compensated data G″green (step S700).

The green compensated data G″green outputted from the luminance compensating part 230 are the green data to be outputted from the data compensating part 502. The red compensated data G″red and the blue compensated data G″blue outputted from the output part 250 are the blue and red data to be outputted from the data compensating part 502.

Accordingly, the output timing of the green compensated data G″green may be adjusted to be synchronized with the output timing of the red compensated data G″red and the blue compensated data G″blue.

In an exemplary embodiment, the data compensating part 502 further includes the delaying part 570 such that the output timing of the compensated data G″may be controlled.

According to exemplary embodiments as described herein, luminance difference due to position difference in a display panel is compensated such that luminance ununiformity of the display panel is effectively prevented, and display quality of the display panel is thereby substantially improved. In addition, a crosstalk error related with the luminance difference is also effectively prevented such that the display quality of the display panel is substantially improved.

The foregoing is illustrative of the present invention and is not to be construed as limiting thereof Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A method of compensating data, the method comprising:
extending a number of bits of data and outputting extended data of a first color;
compensating a luminance of the extended data of the first color based on a position of the extended data of the first color in a display panel and outputting compensated data of the first color; and
outputting compensated data of a second color and compensated data of a third color based on the compensated data of the first color.

2. The method of claim 1, further comprising delaying an output timing of the compensated data of the first color.

3. The method of claim 1, wherein the first color is green, the second color is red, and the third color is blue.

4. The method of claim 1, wherein the extending a number of bits of the data comprises using a first lookup table which stores the data, and the extended data of the first color corresponding to the data.

5. The method of claim 1, wherein the compensating a luminance of the extended data of the first color comprises multiplying the extended data of the first color by position data corresponding to the position of the extended data of the first color in the display panel.

6. The method of claim 1, wherein the outputting compensated data of the second color and compensated data of the third color comprises using a second lookup table and a third lookup table,
wherein the second lookup table stores the compensated data of the first color, and the compensated data of the second color corresponding to the compensated data of the first color, and
wherein the third lookup table stores the compensated data of the first color, and the compensated data of the third color corresponding to the compensated data of the first color.

7. The method of claim 6, wherein the second lookup table and the third lookup table store sampled addresses of the compensated data of the second color and sampled addresses of the compensated data of the third color, respectively.

8. The method of claim 7, wherein the outputting compensated data of the second color and compensated data of the third color further comprises calculating the compensated data of the second color and the compensated data of the third color by linear interpolation.

9. A data compensating apparatus comprising:
a bit extending part which extends a number of bits of data and outputs extended data of a first color;
a luminance compensating part which compensates a luminance of the extended data of the first color based on a position of the extended data of the first color in a display panel and outputs compensated data of the first color; and
an output part which outputs compensated data of a second color and compensated data of third color based on the compensated data of the first color.

10. The data compensating apparatus of claim 9, further comprising a delaying part which delays an output timing of the compensated data of the first color.

11. The data compensating apparatus of claim 9, wherein the first color is green,
the second color is red, and the third color is blue.

12. The data compensating apparatus of claim 9, wherein the bit extending part includes a first lookup table which stores the data and the extended data of the first color corresponding to the data.

13. The data compensating apparatus of claim 9, wherein the luminance compensating part multiplies the extended data of the first color by position data corresponding to the position of the extended data of the first color in the display panel.

14. The data compensating apparatus of claim 9, wherein the output part includes a second lookup table which stores the compensated data of the first color, and the compensated data of the second color corresponding to the compensated data of the first color, and a third lookup table which stores the compensated data of the first color, and the compensated data of the third color corresponding to the compensated data of the first color.

15. The data compensating apparatus of claim 14, wherein the second lookup table and the third lookup table store sampled addresses of the compensated data of the second color and sampled addresses of the compensated data of the third color, respectively.

16. The data compensating apparatus of claim 15, wherein the output part calculates the compensated data of the second color and the compensated data of the third color by linear interpolation.

17. A display apparatus comprising:
a timing controller comprising a data compensating apparatus,
wherein the data compensating part comprises:
a bit extending part which extends a number of bits of data and outputs extended data of a first color;
a luminance compensating part which compensates a luminance of the extended data of the first color based on a position of the extended data of the first color in a display panel and outputs compensated data of the first color; and
an output part which outputs compensated data of a second color and compensated data of a third color based on the compensated data of the first color;
a display panel including a data line and a gate line crossing the data line;
a data driver which converts at least one of the compensated data of the first color, the compensated data of the second color and the compensated data of the third color to an analogue data voltage and outputs the analogue data voltage to the data line; and
a gate driver which outputs a gate signal to the gate line.

18. The display apparatus of claim 17, wherein the data compensating apparatus further comprises a delaying part which delays an output timing of the compensated data of the first color.

19. The display apparatus of claim 17, wherein the bit extending part includes a first lookup table which stores the data, and the extended data of the first color corresponding to the data.

20. The display apparatus of claim 17, wherein the output part includes a second lookup table which stores the compensated data of the first color, and the compensated data of the second color corresponding to the compensated data of the first color, and a third lookup table which stores the compensated data of the first color, and the compensated data of the third color corresponding to the compensated data of the first color.
